(19) United States
(12) Patent Application Publication
(10) Pub. No.: US 2013/0007881 A1
(43) Pub. Date: Jan. 3, 2013

(54) System and Method for Dynamic, Variably-Timed Operation Paths as a Resistance to Side Channel and Repeated Invocation Attacks

(75) Inventors: Clifford Liem, Ottawa (CA); Carlos Nahas, Ottawa (CA)

(73) Assignee: IRDETO CANADA CORPORATION, Ottawa, ON (CA)

(21) Appl. No.: 13/583,965

(22) PCT Filed: Mar. 25, 2010
(86) PCT No.: PCT/CA2010/000409

§ 371 Date: Sep. 11, 2012

(51) Int. Cl. G06F 21/22

(52) U.S. Cl. 726/22

(57) ABSTRACT

A system and method for constructing variably-timed operation paths and applying those paths to any algorithm. In particular, the system and method may be applied to cryptography algorithms as a means to resist side-channel, repeated invocation, and any similar attacks based on the physical characteristics of a system for a given software implementation. The method has the benefit of being generally applicable to any algorithm and has the ability to constrain performance to known timing windows.

### FIELD OF THE INVENTION

The present invention relates generally to software that is resistant to unauthorized analysis. More particularly, the present invention relates to systems and methods for the production of software code that disguises operational paths such that analysis of the code either during run-time or during an attempt of reverse engineering is made more difficult.

### BACKGROUND OF THE INVENTION

In the field of computing, software typically exhibits modular characteristics rather than being monolithic. Moreover, there are oftentimes a number of separate and distinct algorithms employed within any given piece of software. Such disparate algorithms combine in such a manner so as to provide services (i.e., functionalities) that are needed by the software. It is often the case that for one particular service, many different algorithms are available. Generally speaking, an algorithm in this scenario is a sequence of computational steps that carries out a task or a set of tasks. An algorithm can have various sizes. It can be very large, or it can be as small as a set of a few instructions. An algorithm can contain smaller algorithms, which in turn can contain even smaller algorithms. This hierarchy may have any number of levels.

It is well understood that such software can be reverse engineered or otherwise tampered with by an attacker in many ways. Such tampering is undesirable in many commercial applications and gives rise to cryptography to counter any such attacks. In cryptography, a side channel attack is any assault on the underlying algorithm within a targeted software code based on information gained from the physical implementation and related physical characteristics of a cryptosystem. Rather than direct aggression which may include brute force or theoretical weaknesses in the algorithms themselves, such an assault based on the physical characteristics of a system typically involve attributes such as, but not limited to, timing information, power consumption, electromagnetic leaks, or similar physical characteristics. In some instances, even sound can provide an extra source of information which can be exploited to break the cryptosystem. Oftentimes, many side-channel attacks require considerable technical knowledge of the internal operation of the system within which the cryptography is implemented.

Similar to a side channel attack, a repeated invocation attack is another type of technique typically used to assault the underlying algorithm within a targeted software code based on information gained from the physical implementation and related physical characteristics of a cryptosystem. However, such a repeated invocation attack relies on a particular application to navigate the same execution path from one invocation to the next when given a set of inputs. This property enables an attacker to construct a map of the application by executing it repeatedly until uncertain information becomes clearer.

Examples of specific attack techniques include Timing Analysis, Simple Power Analysis (SPA) or Differential Power Analysis (DPA). Each such example involves deep insight into the software code being used as well as repeated invocations of the implementation with controlled inputs. These attack techniques can be useful in obtaining information from an executing algorithm information that can leak, and thereby avail themselves to analytical deduction, may include items such as the exact location of a particular implementation within a system, or which cryptographic algorithm was used by the system. For a side channel or repeated invocation attack to be successful, the implementation is expected to behave in a controlled fashion.

While SPA and DPA take a further step to the attack in calculating variances in power consumption, some of the more advanced attack techniques also make use of statistics and error-correcting code to hone in on any information leakage. As examples, the Rivest, Shamir and Adleman (RSA) algorithm for public-key cryptography, the Diffie-Hellman (D-H) key exchange cryptographic protocol, the Digital Signal Standard (DSS) cryptography standard, the Digital Encryption Standard (DES) cryptography standard, the Advanced Encryption Standard (AES) cryptography standard, and other encryption sub-systems have been attacked through various timing and differential power techniques. A common theme to the side channel or repeated invocation attacks is the need to continually re-invoke the system to answer questions incrementally. Over the course of repeated operation, the predetermined execution of the software leaks partial pieces of information that can be eventually composed into more complete information.

The basis of this existing problem is any given software implementation's predictability when re-invoked. A side channel or repeated invocation attack presumes that the software will behave in a repeatable manner, from which information can be extracted. Additionally, there are other types of attacks on software which depend on this same property. For example, debugging and/or emulation are common forms of attack which rely on repeatability. In these cases, an attacker may, for example, set a breakpoint on a particular function and desire to step through a program to comprehend its operation. When the attacker passes the point of interest, he will re-invoke the program from the beginning expecting to arrive at the same breakpoint in the second invocation.

Typical known prevention methods to thwart side channel or repeated invocation attacks typically employ countermeasures such as reducing the amount of variation in operations in an attempt to reduce the leaking of information. Commonly, variation in operations can be reduced by such efforts as: a) padding fast data paths (e.g., add/sub operations) so that they execute longer than slower data paths (e.g., mul/div operations), b) adding noise to the system, c) making code isochronous, so that it runs in a constant amount of time independent of secret values, or d) using secure CPUs that are physically limited to the outside world.

While these efforts may help reduce the effectiveness of a side channel or repeated invocation attack in specific cases, none of them propose a general approach that can be applied to general algorithm construction. It is, therefore, desirable to provide a more universally useful system and method to prevent side channel or repeated invocation attacks.

### SUMMARY OF THE INVENTION

It is an object of the present invention to obviate or mitigate at least one disadvantage of previous methods of preventing side channel or repeated invocation attacks.

The present invention provides a system and method embodied in software to provide operational paths that are many and varied in order for side-channel or repeated invocation characteristics such as timing duration and power consumption to be procedurally inconsistent, but functionally equivalent, from one invocation to the next. It should be understood that such operational paths are inherent to physical attributes such as, but not limited to memory design and chipset layout. These paths can be constructed using both data-flow and control-flow portions such that timing and power characteristics avoid predictability. Moreover, the computational path choices are constructed at many different levels of granularity in order to increase the amount of unpredictability in timing and power attributes emanating from the system.

Furthermore, the computational path choices are constructed such that there are unobvious dependencies between formulae as well as to variables in the program that would not have dependencies under known modular program construction practices. This mode further resists an attacker's ability to draw information out of the system under protection.

In a first aspect, the present invention provides a method of disguising operational paths in computer software source code, the method including: identifying at least one sequence of computational steps embodied in a computer software source code of a computer program; creating alternative operational paths based on an expression path within at least one sequence of computational steps; and generating an attack-resistant sequence of computational steps including the alternative operational paths. The creating step further includes duplicating the expression path corresponding to at least one sequence of computational steps to form a plurality of duplicate expression paths, applying a random choice between the plurality of duplicate expression paths, obtaining alternative operations equivalent to operations within the plurality of duplicate expression paths, expanding the alternative operations by insertion of one or more identities according to limitations of the input timing window, and binding non-special inputs of each the one or more identities to constants and/or variables of the computer program to form one or more related decoys, forming an input timing window corresponding to criteria established by a user of the computer program, wherein the attack-resistant sequence of computational steps includes the expression path, the alternative operations, the one or more identities, and the decoy.

In another aspect, the present invention provides a system for disguising operational paths in a computer software source code, the system including: a set of machine executable code segments operable to produce software code that randomizes circuit selection of computational steps contained in the computer software source code, the machine executable code executable to perform the steps of: identifying at least one sequence of computational steps embodied in a computer software source code of a computer program; creating alternative operational paths based on an expression path within at least one sequence of computational steps; and generating an attack-resistant sequence of computational steps including the alternative operational paths. The creating step further includes duplicating the expression path corresponding to at least one sequence of computational steps to form a plurality of duplicate expression paths, applying a random choice between the plurality of duplicate expression paths, obtaining alternative operations equivalent to operations within the plurality of duplicate expression paths, expanding the alternative operations by insertion of one or more identities according to limitations of the input timing window, and binding non-special inputs of each the one or more identities to constants and/or variables of the computer program to form one or more related decoys, forming an input timing window corresponding to criteria established by a user of the computer program, wherein the attack-resistant sequence of computational steps includes the expression path, the alternative operations, the one or more identities, and the decoy.

In yet a further aspect, the present invention provides an apparatus for disguising operational paths in computer software source code, the apparatus including: means for identifying at least one sequence of computational steps embodied in a computer software source code of a computer program; means for creating alternative operational paths based on an expression path within at least one sequence of computational steps; and means for generating an attack-resistant sequence of computational steps including the alternative operational paths. The means for creating further includes means for duplicating the expression path corresponding to at least one sequence of computational steps to form a plurality of duplicate expression paths, means for applying a random choice between the plurality of duplicate expression paths, means for obtaining alternative operations equivalent to operations within the plurality of duplicate expression paths, means for expanding the alternative operations by insertion of one or more identities according to limitations of the input timing window, means for binding non-special inputs of each the one or more identities to constants and/or variables of the computer program to form one or more related decoys, and means for forming an input timing window corresponding to criteria established by a user of the computer program, wherein the attack-resistant sequence of computational steps includes the plurality of duplicate expression paths, the alternative operations within each the plurality of duplicate expression paths, the one or more identities, and the decoys.

In yet another aspect, the present invention provides a computer readable memory medium storing computer software code for disguising operational paths in computer software source code, the computer software code executable to perform the steps of: identifying at least one sequence of computational steps embodied in a computer software source code of a computer program; creating alternative operational paths based on an expression path within at least one sequence of computational steps; and generating an attack-resistant sequence of computational steps including the alternative operational paths. The creating step of the computer software code is further executable to perform further steps of: duplicating the expression path corresponding to at least one sequence of computational steps to form a plurality of duplicate expression paths, applying a applying a random choice between the plurality of duplicate expression paths, obtaining alternative operations equivalent to operations within the plurality of duplicate expression paths, expanding the alternative operations by insertion of one or more identities according to limitations of the input timing window, binding non-special inputs of each the one or more identities to constants and/or variables of the computer program to form one or more related decoys, and forming an input timing window corresponding to criteria established by a user of the computer program, wherein the attack-resistant sequence of computational steps includes the plurality of duplicate expression paths, the alternative operations within each the plurality of duplicate expression paths, the one or more identities, and the decoys.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures.

FIG. 1 illustrates a known computer system in which the present invention may be embodied.

FIG. 2 illustrates an overall process in accordance with the present invention.

FIG. 3 is a flowchart showing steps for build-time creation of an attack-resistant algorithm in accordance with the present invention illustrated in FIG. 2.

FIG. 4 illustrates static and dynamic views of run-time execution in accordance with the present invention illustrated in FIG. 2.

FIG. 5 is a flowchart showing steps for creating a palette of equivalents and identities as used in the build-time flowchart in accordance with the present invention illustrated in FIG. 3.

FIG. 6 illustrates a build-time creation example of a specific circuit path within a target timing window used in accordance with the present invention.

FIG. 7 illustrates one type of calculation path selection in the form of jump indirect path selection that may be used in accordance with the present invention.

FIG. 8 illustrates another type of calculation path selection in the form of function pointer table selection that may be used in accordance with the present invention.

FIG. 9 illustrates an example of run-time selection of variably-timed paths used in accordance with the present invention.

FIG. 10 illustrates a specific implementation a selecting from two differently timed data-paths representative of Block C as shown in FIG. 9.

### DETAILED DESCRIPTION

As mentioned above, an algorithm is generally a sequence of computational steps that carries out a task or a set of tasks. In the present invention, the definition of algorithm should be understood to also encompass the implementations of algorithms. Therefore, an algorithm can be a set of computer instructions or a piece of high level software programming that carries out a task or a set of tasks on a computing device.

Generally, the present invention provides a method and system for processing existing algorithms at the source code level in order to produce an implementation of algorithms that is resistant to side-channel or repeated invocation attacks. The algorithm implementation produced by the present invention will contain explicitly inserted variably-timed calculation paths which will naturally inhibit side-channel analysis. The variable timing of the paths can be controlled to windows of known timing (i.e., bottom-level and upper-level thresholds), providing the means to parameterize and control behavior according to the real-time constraints.

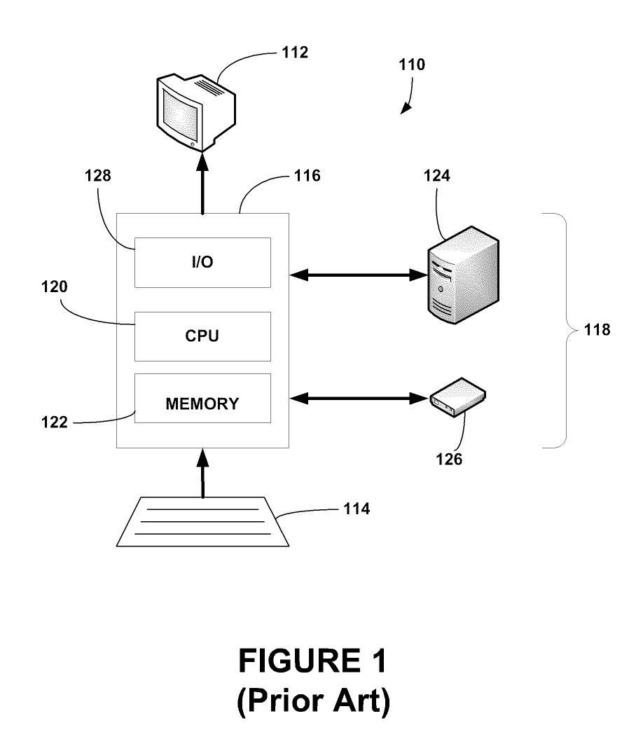

It should be understood that the present invention may be practiced upon any given computer system. A simplified example of a computer system upon which the invention may be performed is presented as a block diagram in FIG. 1. This computer system 110 includes a display 112, keyboard 114, computer 116 and external devices 118.

The computer 116 may contain one or more processors or microprocessors, such as a central processing unit (CPU) 120. The CPU 120 performs arithmetic calculations and control functions to execute software stored in an internal memory 122, preferably random access memory (RAM) and/or read only memory (ROM), and possibly additional memory 124. The additional memory 124 may include, for example, mass memory storage, hard disk drives, floppy disk drives, magnetic tape drives, compact disk drives, program cartridges and cartridge interfaces such as those found in video game devices, removable memory chips such as EPROM or PROM, or similar storage media as known in the art. This additional memory 124 may be physically internal to the computer 116, or external as in FIG. 1.

The computer system 110 may also include other similar means for allowing computer programs or other instructions to be loaded. Such means can include, for example, a communications interface 126 which allows software and data to be transferred between the computer system 110 and external systems. Examples of communications interface 126 can include a modem, a network interface such as an Ethernet card, a serial or parallel communications port. Software and data transferred via communications interface 126 are in the form of signals which can be electronic, electromagnetic, and optical or other signals capable of being received by communications interface 126. Multiple interfaces, of course, can be provided on a single computer system 110.

Input and output to and from the computer 116 is administered by the input/output (I/O) interface 128. This I/O interface 128 administers control of the display 112, keyboard 114, external devices 118 and other such components of the computer system 110.

The invention is described in these terms for convenience purposes only. It would be clear to one skilled in the art that the invention may be applied to other computer or control systems 110. Such systems would include all manner of appliances having computer or processor control including telephones, cellular telephones, televisions, television set top units, point of sale computers, automatic banking machines, lap top computers, servers, personal digital assistants and automobiles.

In the preferred embodiment, the invention is implemented in terms of an intermediate compiler program running on a computer system 110. Standard compiler techniques are well known in the art, and will not be reviewed in detail herein. Two standard references which may provide necessary background are “Compilers Principles, Techniques, and Tools” 1988 by Alfred Aho, Ravi Sethi and Jeffrey Ullman (ISBN 0-201-1008-6), and “Advanced Compiler Design & Implementation” 1997 by Steven Muchnick (ISBN 1-55860-320-4).

Generally, a software compiler is divided into three components, described as the front end, the middle, and the back end. The front end is responsible for language dependent analysis, while the back end handles the machine-dependent parts of code generation. Optionally, a middle component may be included to perform optimizations that are independent of language and machine. Typically, each compiler family will have only one middle, with a front end for each high-level language and a back end for each machine-level language. All of the components in a compiler family can generally communicate in a common intermediate language so they are easily interchangeable. This intermediate language is generally in a form which exposes both control- and data-flow so that they are easily manipulated. Such an intermediate form may be referred to as flow-exposed form. In the preferred embodiment of the invention, it is the intermediate code that will be manipulated to make the desired areas of the input software tamper-resistant.

The invention can most easily be applied to software code in Static Single Assignment (SSA) form. SSA is a well-known, popular and efficient flow-exposed form used by software compilers as a code representation for performing analyses and optimizations involving scalar variables. Effective algorithms based on SSA have been developed to address constant propagation, redundant computation detection, dead code elimination, induction variable elimination, and other requirements. Of course, the method of the invention could be applied to flow-exposed forms other than SSA, where these provide similar levels of semantic information, as in that provided in Gnu CC. Gnu CC software is currently available at no cost from the Free Software Foundation. Similarly, the method of the invention could be applied to software in its high level or low level forms, if such forms were augmented with the requisite control-flow and data-flow information. This flexibility will become clear from the description of the encoding techniques described hereinafter.

The present invention has the advantage of being generally applicable to any algorithm and being encapsulated in a build-time pre-compilation tool. Therefore, the present invention can be applied to any software application including cryptographic ciphers, hashes, and the like. Furthermore, the present invention may be applied to any software where there is the threat of side-channel attacks. Additionally, the inventive system and method may be applied generally to any algorithm such that it is also a resistance to other types of attacks. These attacks can include debugging and emulation attacks which rely on the predictability and repeatability of the software. For example, a debugging attack typically relies on the ability to set a break-point and repeatedly invoke an application from the beginning with an expectancy to arrive at exactly the same break-point from one invocation to the next. For clarity in describing the invention, the term side-channel attack will be used throughout, though it should be readily apparent that the present invention is useful against repeated invocation or similar attacks.

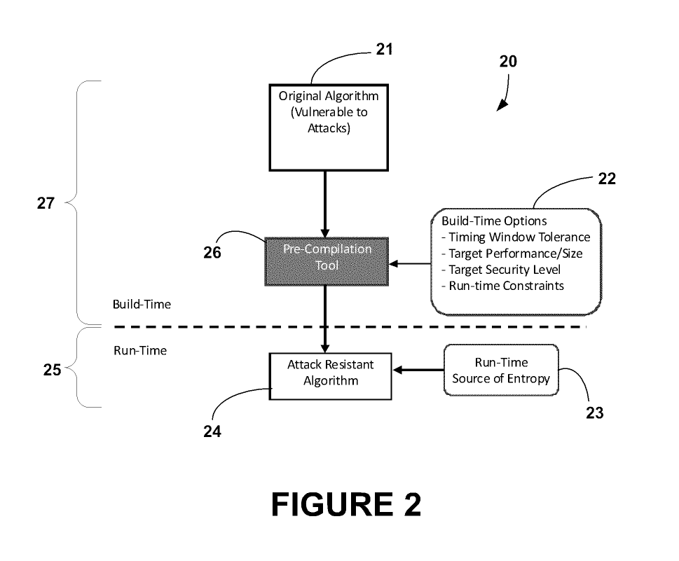

With regard to FIG. 2, a simplified diagram shows the overall process 20 to create an attack-resistant algorithm in accordance with the present invention. The process 20 is generally illustrated both in terms of build-time 27 which includes the compilation and build cycle for establishing dynamic, variably-timed operation paths with regard to an original algorithm 21, and in terms of run-time 25 which includes the execution and run cycle of the attack resistant form 24 of the algorithm 21. During the build-time 27, the original algorithm 21 is presented to a pre-compilation tool 26 which incorporates the system and method of the present invention as later described in more detail. Generally speaking, the pre-compilation tool 26 incorporates build-time options 22 such as, but not limited to: timing window tolerance; target performance, size, and/or security level; and/or run-time constraints. Such options 22 are used by the present invention to produce an attack resistant algorithm 24 based upon the original algorithm 21. During the run-time 25, random circuit selection occurs with regard to randomness provided by way of a run-time source of entropy 23.

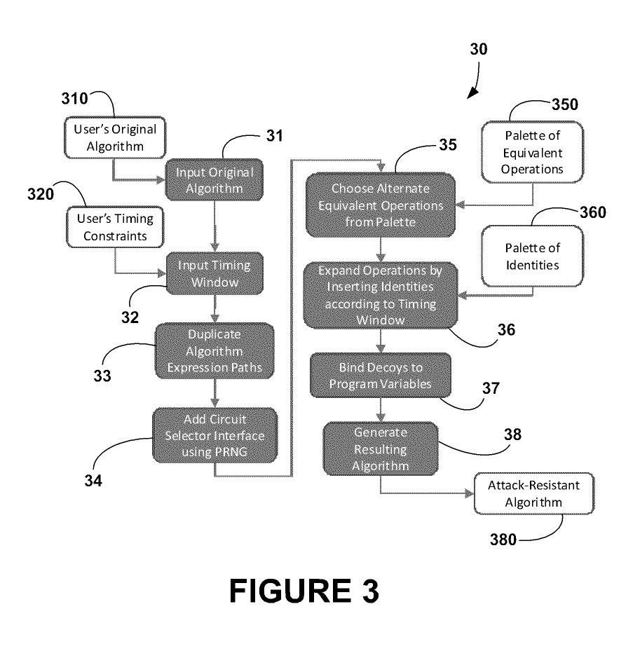

A more detailed embodiment of the present invention in terms of build-time is shown in FIG. 3. Here, a build-time flow chart 30 is illustrated showing the build-time method for creating an attack-resistant algorithm in accordance with the present invention. As shown, the method begins by parsing and interpreting the user's original algorithm and timing constraints. In particular, the inventive method at step 31 obtains the original algorithm 310 and further at step 32 processes the timing window of the given algorithm 310 with regard to the user's timing constraints 320. It should be understood that such timing constraints may vary in accordance with any given user's operating environment. Once the user's original algorithm 310 and given timing constraints 320 are parsed and interpreted, the expression paths of the algorithm 310 are duplicated at step 33.

Duplicating the expression path provides the input to creating essentially the same execution in a second path. The duplicated path does not contain exactly the same operations, but rather, alternative expressions from the palette of choices. At run-time, a duplicated path executes the same function with different operations than the original path.

Next, an interface is provided at step 34 whereby a circuit selector mechanism is inserted. The circuit selector mechanism uses the available sources of entropy at run time. The source of entropy is an input to a pseudorandom number generator (PRNG) which acts in a known manner in order to generate randomness used in selecting alternative circuits. Effective software-based PRNG algorithms are known. Otherwise, a trusted hardware random number generator may be used to produce random numbers and the values returned back via secure channels. Such details of the PRNG are well within the common knowledge in the programming art and are not further described herein.

Once the circuit selector interface is added using the PRNG at step 34, the inventive method then proceeds at step 35 to replace operations in the algorithm with alternate operations while keeping within the timing window constraints. This is accomplished through the use of a palette of equivalent operations 350, described later. Likewise, at step 36 the operations in the algorithm are further expanded by insertion of identities in accordance with the timing window constraints by way of a palette of identities 360, described later. Next, at step 37, decoy identities are bound to constants and variables of the algorithm to provide a decoy to meaningful information sought by an attacker. The inventive method at step 38 then generates the resulting attack-resistant algorithm 380 for use at run-time.

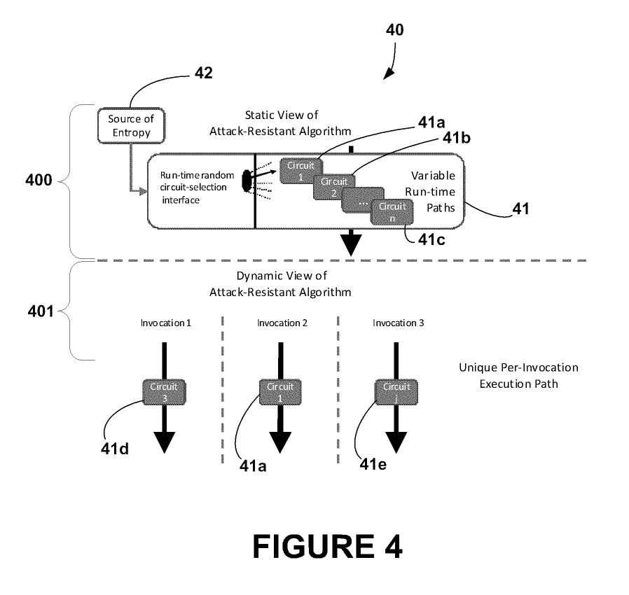

In regard to FIG. 4, a schematic 40 showing alternative views 400, 401 of run-time is presented in accordance with the present invention. Here, a static view 400 of the present invention is contrasted with a dynamic view 401 of the present invention. Statically, the circuit selector 41 has a choice of variable run-time paths embodied in terms of circuits 41a, 41b, to 41c which are representative of a range of circuits 1, 2, . . . N; where N is an integer greater than one. The circuit selector 41 as shown may randomly choose a circuit from the range of circuits 1 through N in conjunction with randomness provided by a source of entropy 42. It should be understood that the range of circuits 1 through N are a set of equivalent circuits. Alternatively, the run-time result of building an attack-resistant algorithm in accordance with the present invention can be illustrated dynamically as seen by view 401. Three invocations are shown such that invocation 1 invokes an execution path 41d corresponding to circuit 3, whereas invocation 2 invokes an execution path 41a corresponding to circuit 1. Likewise, invocation 3 invokes and execution path 41e corresponding to circuit j. In this manner, it is readily apparent each invocation of the algorithm will effectively run a different circuit (e.g., 41a through 41e). Moreover, the path taken upon each run-time invocation is advantageously a unique run-time instance of the algorithm.

The palette of equivalent operations and identities will now be discussed in more detail. Generally speaking, known techniques can be utilized to construct equivalent operations that comprise any given algorithm. For example, Mixed Boolean-Arithmetic (MBA) expressions, such as those disclosed by Zhou et al. within “Information Hiding in Software with Mixed Boolean-Arithmetic Transforms”, 8th International Workshop on Information Security Applications (WISA 2007), pp 61-75, Springer Lecture Notes in Computer Science 4867, 2008, is one technique that may be used to create a plurality of identities (i.e., formulae) for all arithmetic and logical operations. These identities have the property of executing the same behavior as a corresponding target operation. However, each of the plurality of identities will have a different associated timing (i.e., execution delay).

As an example of this behavior, in a 32-bit, 2's-complement context, the ADD (i.e., +) operation can be equivalently implemented using the following formulae:

ADD1(x,y)=x+y 1.

ADD2(x,y)=x−˜y−1 2.

ADD3(x,y)=2*(x|y)−(x̂y) 3.

The ADD1 formula above is the most readily apparent implementation of the ADD operation from the above three equivalent formulae. However, the other two formulae, ADD2 and ADD3, each provide exactly the same behavior based on commonly used 32-bit, 2's-complement operations. As well, it should also be noted that similar formulae can of course be constructed for bit-sizes beyond 32. Although the operational behavior is the same for all three formulae shown above, the timing characteristics are expected to be different. The ADD1 formula contains one arithmetic operation, while the ADD2 formula contains three operations. Likewise, the ADD3 operation contains 4 operations, one of which being a multiplication which typically takes more time than other operations.

Consider now creating an identity formula where a value, v, simply adds, then subtracts a constant:

Identity(v,c)=v+c−c

The above identity produces the value, v, independent of the value of c. Furthermore, c only needs to remain constant during the calculation of the identity formula. Therefore, c can be a variable in the programming sense. Now, consider replacing the ADD operation in the identity formula with one of the ADD formulae 1, 2, or 3, described above. For example ADD3 in the above identity then becomes:

$$\begin{matrix}Identity ( v , c ) = ADD 3 ( v , c ) - c \\ = {2}^{*} ( v \vert c ) - ( {v}^{⋀} c ) - c\end{matrix}$$

The result is now an identity operation for v which has a dependency on any constant or variable c, with an additional operation overhead of 5 operations. The dependency on c cannot be traditionally optimized away based on standard compiler optimization practices, because of the use of MBA operations. This illustrates a mechanism for creating arithmetic expressions with two important properties: 1) arbitrary operation size and timing which is under control of the user; and 2) arbitrary dependencies on constants or program variables (which must remain constant during the calculation of the expression.

To achieve the goal of creating these expressions on demand in accordance with the present invention, all the original arithmetic and bitwise operations are visited to construct an equivalency formula. Typically, five to ten formulae are constructed for each operation. Each of the formulae is characterized by the number of operations as well as by the timing characteristics. The final result is a large palette of equivalent operations for each operation needed in the target algorithm. As a result of creating the palette of operations, a very large number of identities can be constructed by combining the equivalency formulae as illustrated by the ADD example above. Each identity is able to bind other program constants or variables in a manner that conceals its intended calculation. These identities are also characterized in terms of operation timing.

The palette of equivalency operations and identities is not restricted to the construction forms (i.e., MBA) mentioned above, but can be arrived at through a number of mathematical means. For example, matrix formulae can be used to create equivalency operations, resulting in new identities. Additionally, finite ring operations of different orders can be used to create other equivalency operations in addition to identities. In using a variety of mechanisms to create equivalent operations, there is an unrestricted opportunity to create a very broad and deep palette of choices.

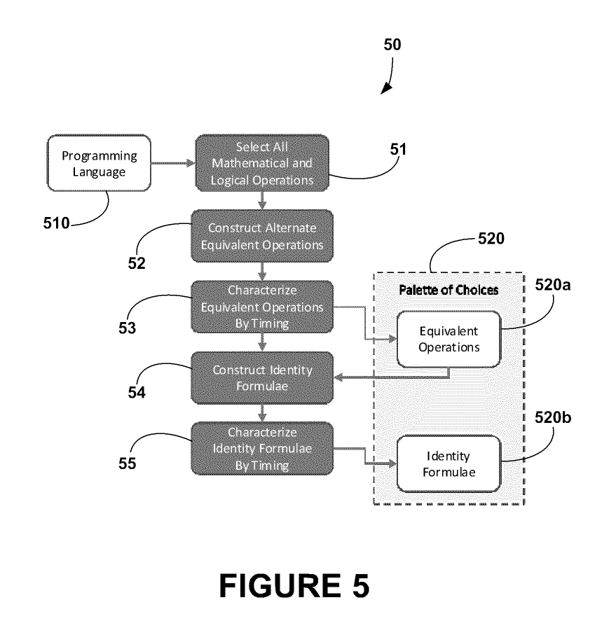

In terms of palette creation, the general method for building a palette of equivalent operations and identities is shown in FIG. 5. Here, palette creation 50 is shown whereby a known programming language 510 (e.g., C) can be distilled to its constituent parts and alternates generated. At step 51, all mathematical and logical operations from a given programming language 510 are selected. Next at step 52, using a method of formulae (e.g., MBA expressions or the like as discussed above), alternate equivalent operations are constructed for each operation selected in step 51. The equivalent operations are then characterized by their timing attributes (i.e., delay through the calculation) at step 53 which also contributes a set of equivalent operations 520a to the palette of choices 520. Next, the equivalent operations 520a are used at step 54 to construct identity formulae.

In terms of the present invention, the identity formulae in general and any given identity operation in particular are a function that has many inputs and one output. One of the inputs to the function is designated as special and is guaranteed to be computed on the output. The other inputs to the function may have any value. Within a bounded system of operation (e.g., 32-bit, 2's-complement arithmetic), the output of the function will always compute the special input. These types of identities are well understood and described further in the aforementioned publication by Zhou et al. titled “Information Hiding in Software with Mixed Boolean-Arithmetic Transforms.” However, while Zhou et al. describes using identities for constant/key hiding and watermark hiding within a program, the present invention provides a unique system and method whereby the identities are used to create varying timings in circuit calculations.

Furthermore, Zhou et al. has shown that the constructed formulae are independent of the values of certain inputs. In the present invention, these inputs are used to increase the ambiguity in the circuit calculations such that attackers are drawn to many disparate points in the program searching for relevant information. The present invention also makes use of identity operations to control the timing of a circuit with the ability to increase the delay through a circuit as much as desired. Still further, as the non-special inputs to the identity may take on any value, the inventive system and method binds these non-special inputs to program variables as a decoy for attackers that are looking for meaningful values that are being calculated.

The identity formulae are characterized at step 55 by their respective timing attributes and a set of identity formulae 520b are generated and stored within the palette of choices 520. The palette of choices 520 is thus now available for use within the system and method in accordance with the present invention. It should therefore be understood that building out a given palette of choices is therefore a necessary part of the present invention though prerequisite to generating alternate operational paths for any given algorithm.

Drawing on the palette of choices (i.e., operation equivalency formulae and identity formulae), any given algorithm can now be constructed as a path with a target timing characteristic. Combining these expressions in multiple ways provides a mechanism to create operation trees of any desired maximum size. Furthermore, some inputs to these formulae need only to remain constant during the calculation of the given formula. This means that these inputs may be bound to any variable in the program for decoys to an attacker as suggested above. These decoys can also be brought in from any calculation path, regardless of whether they are either completely independent paths or the same calculation path. Using these inventive methods, a web of reverse-engineering-resistant dependencies can therefore be created.

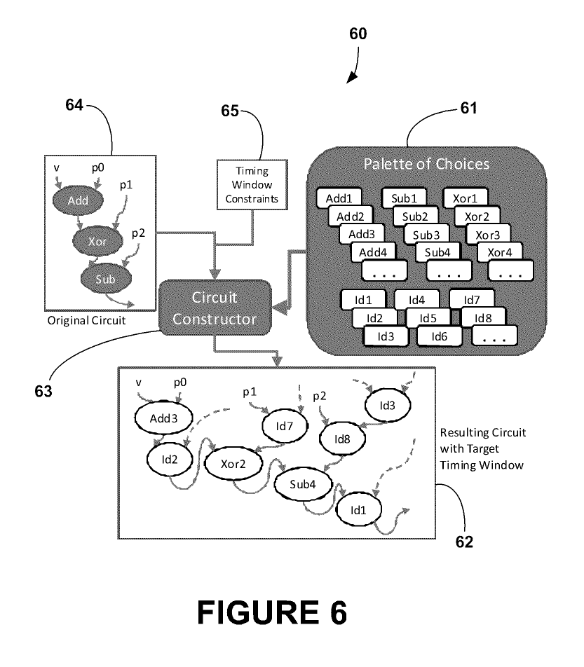

With regard to FIG. 6, there is shown a schematic illustrating the build-time creation 60 of a specific circuit with a target timing window. The original expression 64 forming the original circuit along with the timing window constraints 65 are input to a circuit constructing tool 63 which performs automatic selection. Here, the original circuit 64 includes operations Add, Xor, and Sub. The circuit constructor 63 creates an equivalent expression path 62 using the palette of choices 61, while targeting the timing window 65 requested. Here, the palette of choices contains: a set of alternative Add operations: Add1, Add2, Add3, Add4 . . . ; a set of alternative Sub operations: Sub1, Sub2, Sub3, Sub4 . . . ; a set of alternative Xor operations; and a set of identities dl, Id2, Id3, Id4, Id5, Id6, Id7, Id8 . . . which have been generated as earlier described. In addition to the timing of the equivalent operations, identity operations can also be selected and inserted —e.g., Id1, Id2, Id3, Id7, and Id8 as shown. These operations allow the timing of the expression path to be altered, but also allow decoy dependencies to other variables or constants to be created. The decoy dependencies are indicated by dashed lines. The identity operations have an interesting property that allows them to be flexibly placed at literally any point in the expression path. As a result, the circuit selector 63 can meet the target timing window at fine granularity.

In accordance with the present invention, the ability to create an operation tree of any size provides the capacity to create multiple code paths of varying timing for any desired set of operations. Combining this with an ability to choose different paths at run-time provides a resistance to side-channel attacks. Moreover, providing that the different paths must be driven through a PRNG and related source of entropy results in enhanced tamper resistance.

With regard to the circuit constructor 63, it should be noted that making a choice among calculation paths may be accomplished via a variety of mechanisms without straying from the intended scope of the present invention. Indeed, this circuit selection process may include, but are not limited to, the following methods:
Control-flow conditional statements (e.g., conditional branches)
Jump indirect tables (e.g., may arise from a switch statement)
Indirect calls to functions (e.g., may arise from placing function pointers in a table)
Software Multiplexers (e.g., effectively choosing operations by multiplication by 1 or 0)

Though these mechanisms are well understood and the constructs needed to build the related methods of selection are known, the present invention uses these methods in a novel manner to create circuit selectors for variably timed paths of operation. In the present invention, blocks of computation are randomly chosen at run-time (i.e., execution time) such that an attacker of the code cannot easily predict how the software will behave from one invocation to another. Accordingly, it should be readily understood that the random selection of paths is a unique aspect of the present invention.

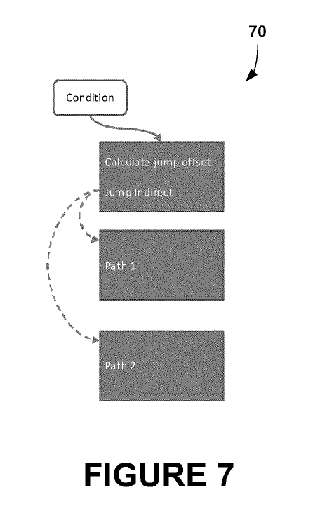

With regard to FIG. 7, a compilation result of a construct 70 formed by a conditional control-flow and jump indirect table methods is shown. A conditional control-flow statement is the most straightforward manner to choose between two paths and can be shown by:

if(cond) {

Path1;

}
else {

Path2;

}

However, the conditional control-flow has the disadvantage of becoming a set of branch instructions in the final program which can arguably be easily reverse-engineered by an attacker. The further use of jump indirect tables may therefore be beneficial. A jump indirect table can often arise as a compiler optimization from a set of switch/case statements:

switch(cond) {
case A:

path1;

case B:

path2;

}

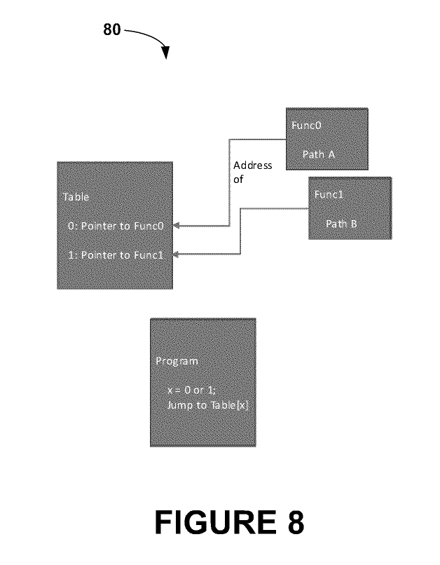

With regard to FIG. 8, function pointer selection 80 can be seen that paths can be chosen using a function pointer table whereby indirect function calls are shown.

Taking the pointers (i.e., addresses) of several functions and placing them as elements of an array (i.e., a table) gives the ability to choose between different paths. This is done simply by choosing different elements of the array, for example by:

a[0]=&func0( );

a[1]=&fun1( )

As shown in FIG. 8, a call to a[x] where x is 0 or 1 allows either of func0 or func1 to be called.

Each of the previous cases (control-flow conditional statements, jump indirect tables, and indirect calls to functions) uses a control-flow method of choosing a path. In other words, the program jumps to the position of the path to be executed and only the path chosen is executed. In contrast for the software multiplexer case, the present invention defines a method where both (or more) paths are executed, then, after the calculations have taken place, only one of the results is actually selected. For example, consider a two-element table where the elements are filled with 0 and 1

A[0]=0

A[1]=1

Result=A[x]*Path1+A[y]+Path2
If x=1 and y=0, then Path1 is chosen.
If x=0 and y=1, then Path2 is chosen.

The example shown above can be extrapolated to more than two paths. Additionally, other operations other than multiplication can be used to achieve a similar result. This is a novel use of tables and arithmetic operations to create a circuit selector.

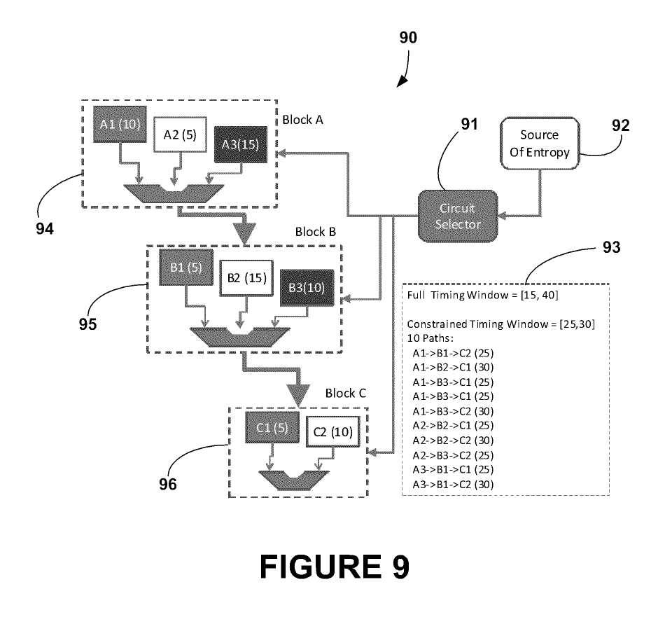

With regard to FIG. 9, run-time selection of variably-timed paths 90 is illustrated. Here, it can be seen how variably-timed operation blocks 94, 95, 96 may be set-up to guarantee a specific timing window 93. FIG. 9 shows three successive blocks of operation paths: A, B, and C. Each of these blocks have alternative and equivalent implementations inside:

Block A has 3 implementations: A1, A2, A3

Block B has 3 implementations: B1, B2, and B3

Block C has 2 implementations: C1, C2

Each of the implementations has an expected timing as shown as a value in brackets. The circuit selector 91 chooses a path that executes A->B->C through the possible implementations. There are eighteen possible paths through the circuit with a full timing window of [15, 40]. The fastest circuit is A2->B1->C1=15, and the slowest circuit is A3->B2->C2=40.

The timing window of the circuit can be further constrained by restricting the paths that the circuit selector 91 chooses. For example, a constrained timing window of [25, 30] means that the circuit selector can choose from ten possible paths (as listed within 93). As shown in this small example, a wide variety of variably timed paths can be constructed, while maintaining a constrained timing window for the overall circuit. This achieves the goal of a dynamically diverse execution of the circuit, which resists attacks based upon re-invocation of the software, while maintaining a consistent performance window for the overall circuit, which is important for the real-time constraints of the overall system. Sources of entropy 92 are needed to provide an input to the run-time decisions including choosing the circuit paths. Known PRNG techniques may then be seeded using these sources of entropy. Examples of sources of entropy include, but are not limited to: 1) date & time sources; 2) process identifiers (PIDs); 3) available memory addresses; 4) run-time state of system information; or 5) hardware sources of entropy (e.g., Trusted Platform Module (TPM)).

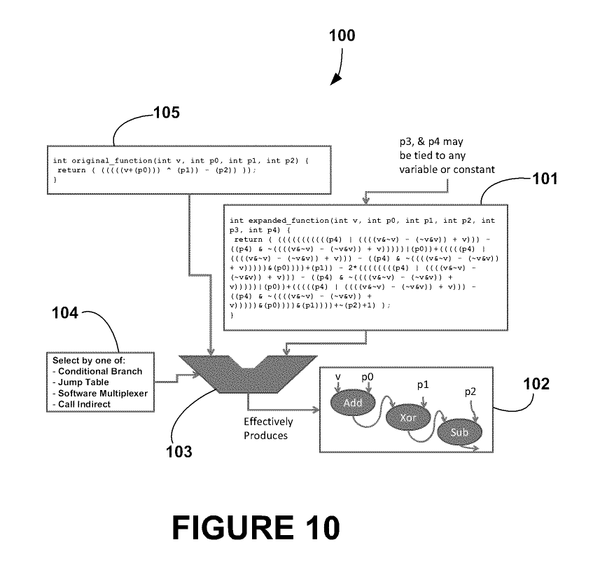

With regard to FIG. 10, there is illustrated a process 100 of selecting from two differently timed data paths. Here, a tangible example of two expression paths (as functions 101 and 105) are shown with different timing, yet performing equivalent function. Encapsulation of the path as a function is just one example. Additionally, this can also be done as inline code or in basic-blocks. FIG. 10 may also be viewed as corresponding to Block C of FIG. 9 such that the functions C1(5) and C2(10) in FIG. 9 correspond to function 101 and 105, respectively. Through software multiplexer 103, the functions 101 and 105 are combined to produce the operational path 102 as shown. The circuit selection process being made by the software multiplexer in conjunction with a randomly selected one of the processes 104.

The method steps of the invention may be embodied in sets of executable machine code stored in a variety of formats such as object code or source code. Such code has been described generically herein as algorithms, alternative algorithms, programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

It would also be clear to one skilled in the art that this invention need not be limited to the existing scope of computers and computer systems. Credit, debit, bank, and smart cards could be encoded to apply the invention to their respective applications. An electronic commerce system in a manner of the invention could for example, be applied to parking meters, vending machines, pay telephones, inventory control or rental cars and using magnetic strips or electronic circuits to store the software and passwords. Again, such implementations would be clear to one skilled in the art, and do not take away from the invention. The above-described embodiments of the present invention are intended to be examples only. It should be equally apparent that many different types of software, or pieces of software, may benefit from strengthened security by way of the present invention. Moreover, alterations, modifications, and variations may be effected to the particular embodiments by those of skill in the art without departing from the scope of the invention, which is defined solely by the claims appended hereto.

1. A method of disguising operational paths in computer software source code, said method comprising:
identifying at least one sequence of computational steps embodied in a computer software source code of a computer program;
creating alternative operational paths based on an expression path within said at least one sequence of computational steps; and
generating an attack-resistant sequence of computational steps including said alternative operational paths.

2. The method as claimed in claim 1, wherein said creating step further includes
duplicating said expression path corresponding to said at least one sequence of computational steps to form a plurality of duplicate expression paths:
applying a random choice between said plurality of duplicate expression paths;
obtaining alternative operations equivalent to operations within said plurality of duplicate expression paths;
expanding said alternative operations by insertion of one or more identities according to limitations of said input timing window; and
binding non-special inputs of each said one or more identities to constants and/or variables of said computer program to form one or more related decoys;
forming an input timing window corresponding to criteria established by a user of said computer program;
wherein said attack-resistant sequence of computational steps includes said expression path, said alternative operations, said one or more identities, and said decoy.

3. The method as claimed in claim 2, wherein said at least one sequence of computational steps includes a set of computer instructions.

4. The method as claimed in claim 2, wherein said at least one sequence of computational steps includes a piece of high level software programming that carries out a task on a computing device.

5. The method as claimed in claim 2, wherein said at least one sequence of computational steps includes a piece of high level software programming that carries out a set of tasks on a computing device.

6. The method as claimed in claim 2, wherein said forming step includes obtaining predetermined constraint options, said predetermined constraint options including said criteria selected from a group consisting of timing window tolerance, target performance, target size, target security level, and run-time constraints.

7. The method as claimed in claim 6, wherein said identifying step includes parsing and interpreting said at least one sequence of computational steps along with said predetermined constraint options.

8. The method as claimed in claim 2, wherein obtaining step acquires said alternative operations from a palette of equivalent operations.

9. The method as claimed in claim 8, wherein expanding step acquires said one or more identities from a palette of identities.

10. The method as claimed in claim 9, wherein said palette of equivalent operations and said a palette of identities are pre-established relative to a computer programming language in which said computer program is written.

11. The method as claimed in claim 10, wherein said palette of equivalent operations and said palette of identities together form a palette of choices, said palette of choices being created by steps including:
selecting all mathematical and logical operations from said computer programming language;
constructing a set of pre-established operations that are equivalents of said mathematical and logical operations;
characterizing said set of pre-determined operations by their related timing attributes;
constructing a set of identity formulae relative to said set of pre-established operations; and
characterizing said set of identity formulae by their related timing attributes.

12. The method as claimed in either one of claim 2 or 11, wherein, upon an execution and run cycle of said attack-resistant sequence of computational steps, said plurality of duplicate expression paths, said alternative operations within each said plurality of duplicate expression paths, said one or more identities, and said decoys are subjected to a circuit selection process.

13. The method as claimed in claim 12, wherein said circuit selection process forms a unique circuit path using said alternative operations, said one or more identities, and said decoy.

14. The method as claimed in claim 13, wherein said circuit selection process includes one or more selection mechanisms selected from a group consisting of control-flow conditional statements, jump indirect tables, indirect calls to functions, and software multiplexers.

15. The method as claimed in claim 14, wherein said one or more selection mechanisms are randomized.

16. A system for disguising operational paths in a computer software source code, said system comprising:
a set of machine executable code segments operable to produce software code that randomizes circuit selection of computational steps contained in said computer software source code, said machine executable code executable to perform the steps of:
identifying at least one sequence of computational steps embodied in a computer software source code of a computer program;
creating alternative operational paths based on an expression path within said at least one sequence of computational steps; and
generating an attack-resistant sequence of computational steps including said alternative operational paths.

17. The system as claimed in claim 16, wherein said creating step further includes:
duplicating said expression path corresponding to said at least one sequence of computational steps to form a plurality of duplicate expression paths;
applying a random choice between said plurality of duplicate expression paths;
obtaining alternative operations equivalent to operations within said plurality of duplicate expression paths;
expanding said alternative operations by insertion of one or more identities according to limitations of said input timing window; and
binding non-special inputs of each said one or more identities to constants and/or variables of said computer program to form one or more related decoys;
forming an input timing window corresponding to criteria established by a user of said computer program;
wherein said attack-resistant sequence of computational steps includes said expression path, said alternative operations, said one or more identities, and said decoy.

18. The system as claimed in claim 17, wherein said at least one sequence of computational steps includes a set of computer instructions.

19. The system as claimed in claim 17, wherein said at least one sequence of computational steps includes a piece of high level software programming that carries out a task on a computing device.

20. The system as claimed in claim 17, wherein said at least one sequence of computational steps includes a piece of high level software programming that carries out a set of tasks on a computing device.

21. The system as claimed in claim 17, wherein said forming step includes obtaining predetermined constraint options, said predetermined constraint options including said criteria selected from a group consisting of timing window tolerance, target performance, target size, target security level, and run-time constraints.

22. The system as claimed in claim 21, wherein said identifying step includes parsing and interpreting said at least one sequence of computational steps along with said predetermined constraint options.

23. The system as claimed in claim 17, wherein obtaining step acquires said alternative operations from a palette of equivalent operations.

24. The system as claimed in claim 23, wherein expanding step acquires said one or more identities from a palette of identities.

25. The system as claimed in claim 24, wherein said palette of equivalent operations and said a palette of identities are pre-established relative to a computer programming language in which said computer program is written.

26. The system as claimed in claim 25, wherein said palette of equivalent operations and said a palette of identities together form a palette of choices, said palette of choices being created by steps including:
selecting all mathematical and logical operations from said computer programming language;
constructing a set of pre-established operations that are equivalents of said mathematical and logical operations;
characterizing said set of pre-determined operations by their related timing attributes;
constructing a set of identity formulae relative to said set of pre-established operations; and
characterizing said set of identity formulae by their related timing attributes.

27. The system as claimed in either one of claim 17 or 26, wherein, upon an execution and run cycle of said attack-resistant sequence of computational steps, said plurality of duplicate expression paths, said alternative operations within each said plurality of duplicate expression paths, said one or more identities, and said decoys are subjected to a circuit selection process.

28. The system as claimed in claim 27, wherein said circuit selection process forms a unique circuit path using said alternative operations, said one or more identities, and said decoy.

29. The system as claimed in claim 28, wherein said circuit selection process includes one or more selection mechanisms selected from a group consisting of control-flow conditional statements, jump indirect tables, indirect calls to functions, and software multiplexers.

30. The system as claimed in claim 29, wherein said one or more selection mechanisms are randomized.

31. An apparatus for disguising operational paths in computer software source code, said apparatus comprising:
means for identifying at least one sequence of computational steps embodied in a computer software source code of a computer program;
means for creating alternative operational paths based on an expression path within said at least one sequence of computational steps; and
means for generating an attack-resistant sequence of computational steps including said alternative operational paths.

32. The apparatus as claimed in claim 31, wherein means for creating further includes:
means for duplicating said expression path corresponding to said at least one sequence of computational steps to form a plurality of duplicate expression paths;
means for applying a random choice between said plurality of duplicate expression paths;
means for obtaining alternative operations equivalent to operations within said plurality of duplicate expression paths;
means for expanding said alternative operations by insertion of one or more identities according to limitations of said input timing window;
means for binding non-special inputs of each said one or more identities to constants and/or variables of said computer program to form one or more related decoys; and
means for forming an input timing window corresponding to criteria established by a user of said computer program;
wherein said attack-resistant sequence of computational steps includes said plurality of duplicate expression paths, said alternative operations within each said plurality of duplicate expression paths, said one or more identities, and said decoys.

33. A computer readable memory medium storing computer software code for disguising operational paths in computer software source code, said computer software code executable to perform the steps of:
identifying at least one sequence of computational steps embodied in a computer software source code of a computer program;
creating alternative operational paths based on an expression path within said at least one sequence of computational steps; and
generating an attack-resistant sequence of computational steps including said alternative operational paths.

34. The computer readable memory medium as claimed in claim 33, wherein said creating step of said computer software code is further executable to perform further steps of:
duplicating said expression path corresponding to said at least one sequence of computational steps to form a plurality of duplicate expression paths, applying a applying a random choice between said plurality of duplicate expression paths;
obtaining alternative operations equivalent to operations within said plurality of duplicate expression paths;
expanding said alternative operations by insertion of one or more identities according to limitations of said input timing window;
binding non-special inputs of each said one or more identities to constants and/or variables of said computer program to form one or more related decoys; and
forming an input timing window corresponding to criteria established by a user of said computer program;
wherein said attack-resistant sequence of computational steps includes said plurality of duplicate expression paths, said alternative operations within each said plurality of duplicate expression paths, said one or more identities, and said decoys.
